(19) United States
(12) Patent Application Publication
(10) Pub. No.: US 2021/0399533 A1
(43) Pub. Date: Dec. 23, 2021

(54) IGNITION APPARATUS

(71) Applicant: Mitsubishi Electric Corporation, Tokyo (JP)

(72) Inventor: Naoki KATAOKA, Tokyo (JP)

(73) Assignee: Mitsubishi Electric Corporation, Tokyo (JP)

(21) Appl. No.: 17/210,608

(22) Filed: Mar. 24, 2021

(30) Foreign Application Priority Data
Jun. 17, 2020 (JP) 2020-104186

(51) Int. Cl. H01T 13/60

(52) U.S. Cl. CPC H01T 13/60; F02P 2017/121

(57) ABSTRACT

There is provided an ignition apparatus that performs optimum energy control by suppressing a secondary current at a time when the ignition plug is consumed, while maintaining the simplicity, the small size, and the low cost and while securing the flammability. The ignition apparatus is provided with a first switching circuit that turns on or off energization from a power source to a primary coil, a secondary coil that is magnetically coupled with the primary coil and supplies a secondary current to an ignition plug, and a controller that decreases the secondary current for a spark discharge by use of an energy-changeable circuit, when determining that the ignition plug has been consumed, based on an output of a plug-consumption detection circuit.

### BACKGROUND OF THE INVENTION

### Field of the Invention

The present disclosure relates to an ignition apparatus.

### Description of the Related Art

In a spark-ignition internal combustion engine, in order to ignite a fuel-air mixture, an ignition plug is mounted therein. A primary current is supplied to a primary coil of the ignition coil, so that a secondary current generated in a secondary coil magnetically coupled with the primary coil causes a spark discharge (discharge ark) to occur in the ignition plug connected with the secondary coil.

In a spark-ignition internal combustion engine, in order to improve gasoline mileage, rarefaction of the fuel in a fuel-air mixture and improvement of the introduction ratio of EGR have been promoted. When rarefaction of the fuel and improvement of the introduction ratio of EGR are promoted, the fuel may become unstable. It is known that to cope with the foregoing problem, the fluidity of the fuel-air mixture is intensified by a rotational flow such as tumbling (a longitudinal vortex) or swirling (a transverse vortex) in a combustion chamber so that the flammability is raised. Strong fluidity causes a spark discharge to be blown out. In order to prevent the blow-off, it is required to heighten the energy of an ignition apparatus.

When the energy of an ignition apparatus is heightened, a large secondary current becomes liable to consume the electrodes of an ignition plug. When due to consumption of the electrodes of the ignition plug, the gap between the electrodes becomes wide, the dielectric breakdown voltage for causing a discharge ark becomes large. However, because the distance between the electrodes of the ignition plug and a flame kernel produced by a discharge becomes large, the flame kernel is suppressed from being cooled (heat lowering) by the electrodes of the ignition plug and hence the ignitability is raised.

Because when the gap between the electrodes of an ignition plug is narrow, the electrodes of the ignition plug cool a flame kernel, it is required to maintain a large-current discharge ark in order to ignite a fuel-air mixture. However, in the case where the gap between the electrodes of an ignition plug is wide, it is made possible to decrease the current of a discharge ark for igniting a fuel-air mixture. Moreover, reduction of the current of a discharge ark can suppress the electrodes of an ignition plug from being further consumed.

Accordingly, in the case where while heightening of the energy of an ignition apparatus is promoted, consumption of the electrodes of an ignition plug occurs, it is desired to suppress a secondary current while maintaining a high secondary voltage. There is known a technology for an ignition apparatus whose ignition energy is variable and in which multiple ignition (frequent ignition) is performed while a sufficient secondary voltage is secured. There has been disclosed a configuration in which within a single power stroke, two or more discharges are continually produced (for example, Patent Document 1). In addition, there has been disclosed a configuration in which in order to obtain a discharge characteristic having a long discharge time, two ignition coils are connected in parallel with each other and the secondary currents are synthesized so as to be supplied in a prolonged manner (for example, Patent Document 2).

### PRIOR ART REFERENCE

### [Patent Literature]

[Patent Document 1] Japanese Patent Application Laid-Open No. 2007-231927

[Patent Document 2] Japanese Patent Application Laid-Open No. 2000-199470

### SUMMARY OF THE INVENTION

In the technology disclosed in Patent Document 1, because two or more discharges are continually produced within a single power stroke, the ignition-discharge current recurrently becomes zero in a time period from the start to the end of an ignition discharge within the power stroke, there exists a problem that the flammability cannot sufficiently be secured. In the technology disclosed in Patent Document 2, because each of the ignition plugs is configured in such a manner that two ignition coils are provided therein in parallel with each other, there exists a problem that the configuration of the apparatus becomes complex and hence the apparatus is upsized and becomes expensive.

The objective of the present disclosure is to provide an ignition apparatus that performs optimum energy control by suppressing a secondary current at a time when the ignition plug is consumed, while maintaining the simplicity, the small size, and the low cost and while securing the flammability.

An ignition apparatus according to the present disclosure includes
an ignition coil having a primary coil and a secondary coil that is magnetically coupled with the primary coil and supplies a secondary current to an ignition plug,
a first switching circuit that turns on or off energization from a power source to the primary coil,
an energy-changeable circuit that can change magnitude of the secondary current,
a plug-consumption detection circuit that detects that the ignition plug has been consumed, and
a controller that performs on/off-control of the first switching circuit so that the secondary current is generated in the secondary coil by a change in magnetic flux generated in the primary coil and a spark discharge is produced in the ignition plug and that decreases the secondary current by use of the energy-changeable circuit, when determining that the ignition plug has been consumed, based on an output of the plug-consumption detection circuit.

The ignition apparatus according to the present disclosure can perform optimum energy control by making the energy-changeable circuit suppress the secondary current at a time when it has been determined that the consumption of the ignition plug is large, while maintaining the simplicity, the small size, and the low-cost configuration and while securing the flammability.

The foregoing and other object, features, aspects, and advantages of the present invention will become more apparent from the following detailed description of the present invention when taken in conjunction with the accompanying drawings.

### BRIEF DESCRIPTION OF THE DRAWINGS

FIG. 1 is a circuit diagram of an ignition apparatus according to Embodiment 1;

FIG. 2 is a hardware configuration diagram of a controller according to Embodiment 1;

FIG. 3 is a chart representing a first set of operation waveforms in the ignition apparatus according to Embodiment 1;

FIG. 4 is a chart representing a second set of operation waveforms in the ignition apparatus according to Embodiment 1;

FIG. 5 is a chart representing a third set of operation waveforms in the ignition apparatus according to Embodiment 1;

FIG. 6 is a chart representing a fourth set of operation waveforms in the ignition apparatus according to Embodiment 1;

FIG. 7 is a circuit diagram of an ignition apparatus according to Embodiment 2;

FIG. 8 is a circuit diagram of an ignition apparatus according to Embodiment 3;

FIG. 9 is a chart representing a first set of operation waveforms in the ignition apparatus according to Embodiment 3;

FIG. 10 is a chart representing a second set of operation waveforms in the ignition apparatus according to Embodiment 3; and

FIG. 11 is a circuit diagram of an ignition apparatus according to Embodiment 4.

### DETAILED DESCRIPTION OF THE PREFERRED EMBODIMENTS

Hereinafter, Embodiments of an ignition apparatus according to the present disclosure will be explained with reference to the drawings.

### 1. Embodiment 1

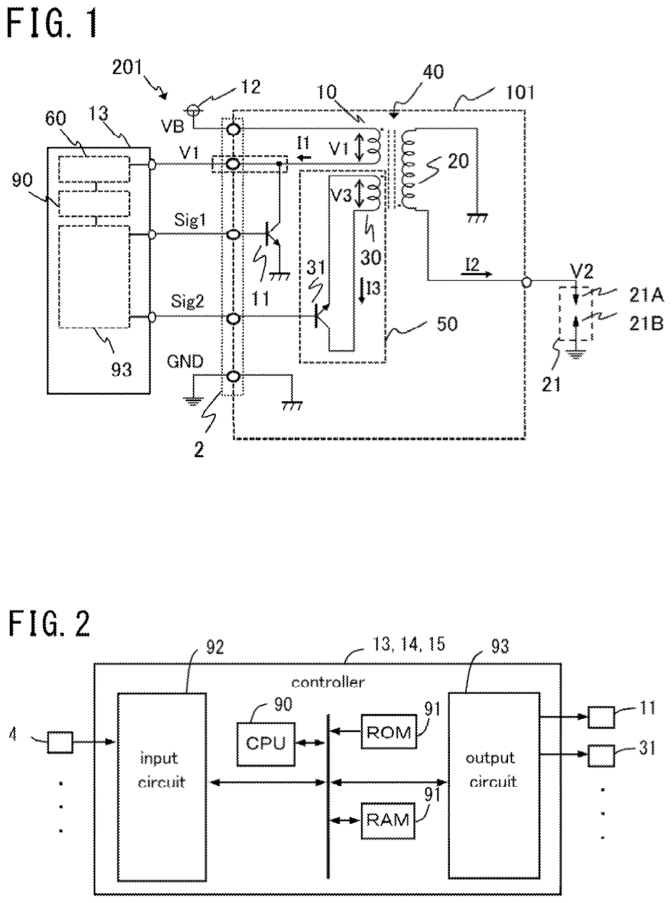

FIG. 1 is a circuit diagram of an ignition apparatus 201 according to Embodiment 1. As represented in FIG. 1, the ignition apparatus 201 is provided with an ignition coil 40 including a primary coil 10, a secondary coil 20, and a tertiary coil 30, an ignition coil apparatus 101 in which a first switching circuit 11 and a second switching circuit 31 are added to the ignition coil 40, an ignition plug 21, an ignition-coil power source 12, a controller 13, and the like.

### <Basic Configuration of Ignition Apparatus>

The ignition plug 21 has a first electrode 21A and a second electrode 21B facing each other via a gap and ignites an inflammable fuel-air mixture in a combustion chamber. The first electrode 21A and the second electrode 21B of the ignition plug 21 are arranged in a combustion chamber (in a cylinder). The first electrode 21A is connected with the secondary coil 20, and the second electrode 21B is connected with the ground.

The ignition coil 40 has the primary coil 10 in which energization magnetic flux is generated through energization, the secondary coil 20 that is magnetically coupled with the primary coil 10, generates a secondary current through a change in the magnetic flux in the primary coil, and supplies the ignition plug 21 with discharging energy so that a spark discharge is caused, and an energy-changeable circuit 50; the energy-changeable circuit 50 has the tertiary coil 30 that is magnetically coupled with the primary coil 10 and the secondary coil 20 and that decreases a secondary current in the secondary coil 20 when energized; the tertiary coil 30 is wound around an iron core shared by the primary coil 10 and the secondary coil 20.

One end of the primary coil 10 is connected with the DC ignition-coil power source 12 via an ignition-coil input connector 2; the other end of the primary coil 10 is connected with the ground via the first switching circuit 11. The both ends of the tertiary coil 30 to be utilized in the energy-changeable circuit 50 are connected with each other via the second switching circuit 31. That is to say, the tertiary coil 30 and the second switching circuit 31 are connected in series with each other in a loop-shaped electric wire. The ground in the ignition coil 40 is earthed via the ignition-coil input connector 2. The ground may be connected, for example, with the negative-polarity end of a battery.

Each of the coils is wound in such a way that the direction of the magnetic flux generated at a time when the first switching circuit 11 is turned on so as to energize the primary coil 10 and the direction of the magnetic flux generated at a time when the second switching circuit 31 is turned on so as to energize the tertiary coil 30 are equal to each other.

The first switching circuit 11 is a switching circuit for turning on or off energization from the DC ignition-coil power source 12 to the primary coil 10. A driving signal Sig1 outputted from the controller 13 is inputted to the first switching circuit 11 and turns on or off the first switching circuit 11.

The second switching circuit 31 is a switching circuit for turning on or off energization of the tertiary coil 30. A driving signal Sig2 outputted from the controller 13 is inputted to the second switching circuit 31 and turns on or off the second switching circuit 31.

In FIG. 1, each of the first switching circuit 11 and the second switching circuit 31 is represented by a circuit utilizing an NPN-type transistor; however, it may be allowed that a PNP-type transistor, an IGBT (Insulated Gate Bipolar Transistor), a MOSFET (Metal Oxide Semiconductor Field Effect Transistor), or the like is utilized.

### <Controller>

In the present embodiment, the controller 13 is a controller for controlling an internal combustion engine. Respective functions of the controller 13 are realized by processing circuits provided in the controller 13. Specifically, as illustrated in FIG. 2, the controller 13 includes, as the processing circuits, a computing processing unit (computer) 90 such as a CPU (Central Processing Unit), storage apparatuses 91 that exchange data with the computing processing unit 90, an input circuit 92 that inputs external signals to the computing processing unit 90, an output circuit 93 that outputs signals from the computing processing unit 90 to the outside, and the like.

It may be allowed that as the computing processing unit 90, an ASIC (Application Specific Integrated Circuit), an IC (Integrated Circuit), a DSP (Digital Signal Processor), an FPGA (Field Programmable Gate Array), each of various kinds of logic circuits, each of various kinds of signal processing circuits, or the like is provided. In addition, it may be allowed that as the computing processing unit 90, two or more computing processing units of the same type or different types are provided and respective processing items are implemented in a sharing manner. As the storage apparatuses 91, there are provided a RAM (Random Access Memory) that can read data from and write data in the computing processing unit 90, a ROM (Read Only Memory) that can read data from the computing processing unit 90, and the like. A voltage detection input 4, switches, and various kinds of sensors such as a crank angle sensor, a cam angle sensor, an intake quantity detection sensor, a water temperature sensor, and a power-source voltage sensor are connected with the input circuit 92; the input circuit 92 is provided with an A/D converter and the like that input the output signals of these sensors and switches to the computing processing unit 90. The output circuit 93 is connected with electric loads such as the first switching circuit 11, the second switching circuit 31, and an injector and is provided with a driving circuit and the like for converting a control signal from the computing processing unit 90 and then outputting the converted control signal to these electric loads.

The computing processing unit 90 runs software items (programs) stored in the storage apparatus 91 such as a ROM and collaborates with other hardware devices in the controller 13, such as the storage apparatus 91, the input circuit 92, and the output circuit 93, so that the respective functions provided in the controller 13 are realized. Setting data items such as a threshold value and a determination value to be utilized in the controller 13 are stored, as part of software items (programs), in the storage apparatus 91 such as a ROM.

As basic control, the controller 13 calculates the rotation speed of the internal combustion engine, the efficiency of filling a fuel-air mixture into a cylinder, the fuel injection amount, the ignition timing, and the like based on inputted output signals and the like of the various kinds of sensors, and then performs driving control of the injector, the first switching circuit 11, the second switching circuit 31, and the like. Each of a controller 13 according to Embodiment 3 and a controller 15 according to Embodiment 4 also has the same hardware configuration.

### <Plug-Consumption Detection Circuit>

A plug-consumption detection circuit 60 detects a voltage generated across the primary coil 10 (or the tertiary coil 30), magnetically connected with the secondary coil, that indirectly detects a voltage across the secondary coil. When the gap width of the ignition plug 21 becomes large, the magnitude (the absolute value) of a secondary voltage V2 at which a discharge ark occurs becomes large. The voltage generated across the primary coil 10 magnetically connected with the secondary coil becomes large in proportional to the magnitude of the secondary voltage V2. When a spark discharge occurs, the plug-consumption detection circuit 60 detects a terminal voltage of the primary coil 10 at the first switching circuit 11 side; from the terminal voltage, the efficiency of filling a fuel-air mixture into a cylinder, the fuel injection amount, the ignition timing, and the like, the gap width, which indicates the plug-consumption state, can be estimated.

The plug-consumption detection circuit 60 is connected with the primary coil 10, at the first switching circuit 11 side, that is magnetically coupled with the secondary coil 20, and compares the detected voltage with a threshold value V1th for recognizing the consumption amount of the ignition plug 21.

### <Ignition Control>

After turning on the first switching circuit 11 so as to turning on energization of the primary coil 10, the controller 13 turns off the first switching circuit 11 so as to turn off the energization of the primary coil 10 and to produce a spark discharge in the ignition plug 21.

The controller 13 calculates an energization period for the primary coil 10 and an ignition timing (ignition crank angle). After turning on the first switching circuit 11 so as to turning on energization of the primary coil 10 during the energization period, the controller 13 turns off the first switching circuit 11 so as to turn off the energization of the primary coil 10, to generate a high voltage across the secondary coil 20, and to produce a spark discharge in the ignition plug 21. The spark discharge continues until magnetic energy accumulated in the iron core of the ignition plug 21 decreases. In the present embodiment, the explanation has been made with a flyback method in which a primary current is cut off so as to make the secondary coil generate a high voltage; however, also in a forward method in which primary-current energization makes the secondary coil generate a high voltage, it is made possible that the first switching circuit is turned on so as to generate a secondary current in the secondary coil.

### <Control of Energy-Changeable Circuit>

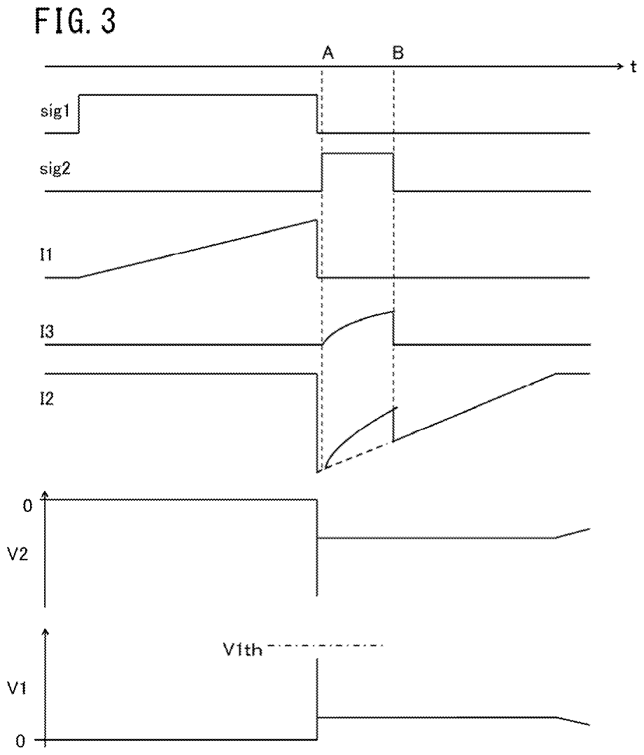

When during a spark discharge, the tertiary coil 30 in the energy-changeable circuit 50 is energized, a current flows in the direction for reducing the secondary current in the secondary coil 20. A first set of operation waveforms of the ignition apparatus 201 will be explained by use of FIG. 3.

FIG. 3 is a chart representing the first set of operation waveforms in the ignition apparatus according to Embodiment 1. FIG. 3 is a timing chart and represents, from top to bottom, the respective waveforms of the driving signal Sig1 for the first switching circuit 11, the driving signal Sig2 for the second switching circuit 31, a primary current I1 flowing in the primary coil 10, a secondary current I2 flowing in the secondary coil 20, the secondary voltage V2 to be applied to the ignition plug 21 side of the secondary coil 20, and a primary voltage V1 to be applied to the first switching circuit 11 side of the primary coil 10.

The controller 13 supplies the driving signal Sig1 to the first switching circuit 11 so as to turn on or off the first switching circuit 11, so that the energization current in the primary coil 10 is made to flow or cut off. When the primary current I1 is cut off, a negative large voltage is generated across the secondary coil 20, due to a mutual inductive action. This voltage causes a dielectric breakdown between the electrodes of the ignition plug 21 and hence a discharge is produced in the gap. In this situation, a negative secondary current I2 flows in the secondary coil 20. The positive direction of the secondary current I2 is indicated by an arrow in FIG. 1.

The controller 13 turns off the first switching circuit 11 and then turns on the second switching circuit 31 after the secondary current has been generated. After the secondary current has been generated, the second switching circuit 31 is turned on, so that energization flux for decreasing the secondary current can be generated. Here, there will be considered the case where the plug-consumption detection circuit 60 determines that the consumption amount of the ignition plug 21 is large. When the consumption amount of the ignition plug 21 is large and hence the gap between the plug electrodes becomes wide, the discharging path becomes long and hence the dielectric breakdown voltage increases. Because in this situation, the flame kernel is suppressed from being cooled (heat lowering) by the plug electrodes, the ignitability of a fuel-air mixture is raised. Therefore, it is not required to maintain a large-current discharge ark for a long time period. Accordingly, consumption of the ignition plug 21 can be suppressed by prolonging the on-period of the Sig2 for performing energization control of the tertiary coil 30 of the energy-changeable circuit 50 so as to further reduce the current flowing in the secondary coil.

FIG. 3 represents the operation at a time when the primary voltage V1 detected by the plug-consumption detection circuit 60 is low and hence the consumption of the ignition plug 21 is small; the primary voltage V1 has not reached the threshold value V1th for determining the consumption amount of the ignition plug 21. The controller 13 turns on the second switching circuit 31 immediately after the secondary current is generated (at a time point A), and then turns off the second switching circuit 31 after an on-period of the second switching circuit 31 elapses (at a time point B). The on-period of the second switching circuit 31 is determined based on the operation state (e.g., the rotation speed, the filling efficiency, or the like) of the internal combustion engine. When the consumption of the ignition plug 21 is small, the electrodes of the ignition plug 21 cool a flame kernel; thus, because in order to secure the ignitability, continuity of the secondary current is required, the on-period of the second switching circuit 31 is set to be short.

Heretofore, there has been explained the case where due to the consumption of the ignition plug 21, the distance between the electrodes of the ignition plug 21 increases and hence the dielectric breakdown voltage is raised. However, also in the case where the fluidity of a fuel-air mixture in a cylinder of a spark-ignition internal combustion engine becomes large and in the case where a discharge ark flows and becomes long, the same phenomenon occurs; thus, Embodiments of the present disclosure deal with this phenomenon. That is to say, a discharge ark is made to flow by the strong fluidity of a fuel-air mixture and hence the length of the discharge ark becomes large; thus, the discharge voltage increases. In this situation, because the contact area between the fuel-air mixture and the discharge ark becomes large, the ignitability is raised. In addition, the distance between the flame kernel and the electrodes of the ignition plug 21 becomes large; thus, the cooling effect that is provided from the electrodes to the flame kernel becomes small. Therefore, even when a large secondary current does not continue, the flammability is not deteriorated. Even in this case, when the primary voltage V1 exceeds the threshold value V1th, the second switching circuit 31 is turned on, so that the secondary current can be reduced. It is very significant to reduce the secondary current that does not contribute to combustion, because consumption of the electrodes of the ignition plug 21 is suppressed and the electric energy of a vehicle can be saved.

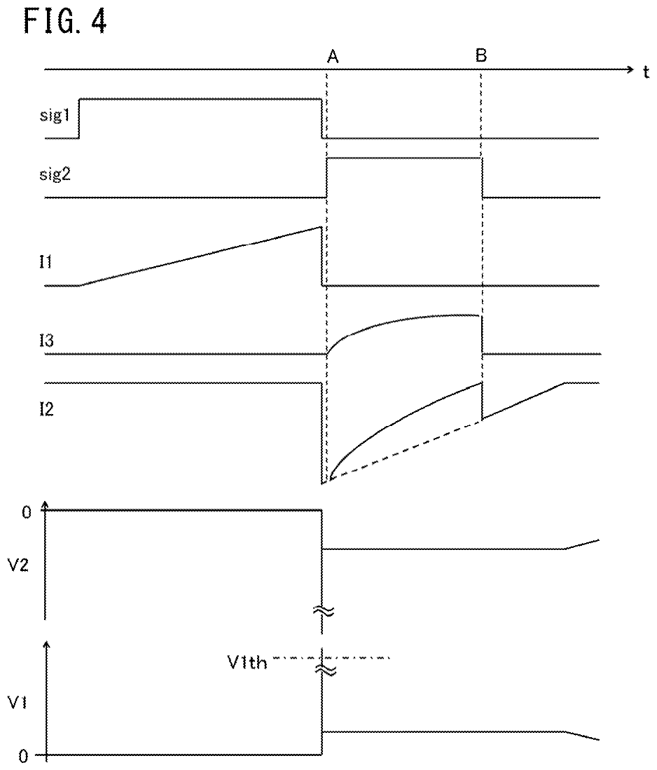

FIG. 4 is a second set of operation waveforms in the ignition apparatus 201. FIG. 4 represents the operation at a time when the voltage detected by the plug-consumption detection circuit 60 is high and hence consumption of the ignition plug 21 is large. In the case where the consumption of the ignition plug 21 is large, the primary voltage V1 detected to determine the consumption amount of the ignition plug 21 exceeds the threshold value V1th; the controller 13 turns on the second switching circuit 31 immediately after the secondary current is generated (at a time point A), and then turns off the second switching circuit 31 after an on-period of the second switching circuit 31 elapses (at a time point B). In the on-period of the second switching circuit 31, the consumption of the ignition plug 21 is large, a distance exists between the electrodes of the ignition plug 21 and a flame kernel, and the electrodes less cool the flame kernel, so that even when the ignition energy is small, the ignitability can be secured. Accordingly, the on-period of the second switching circuit 31 is prolonged so as to lengthen the reduction period of the secondary current. The superfluous secondary current I2 that does not contribute to the ignitability is reduced, so that the consumption of the ignition plug 21 can be suppressed.

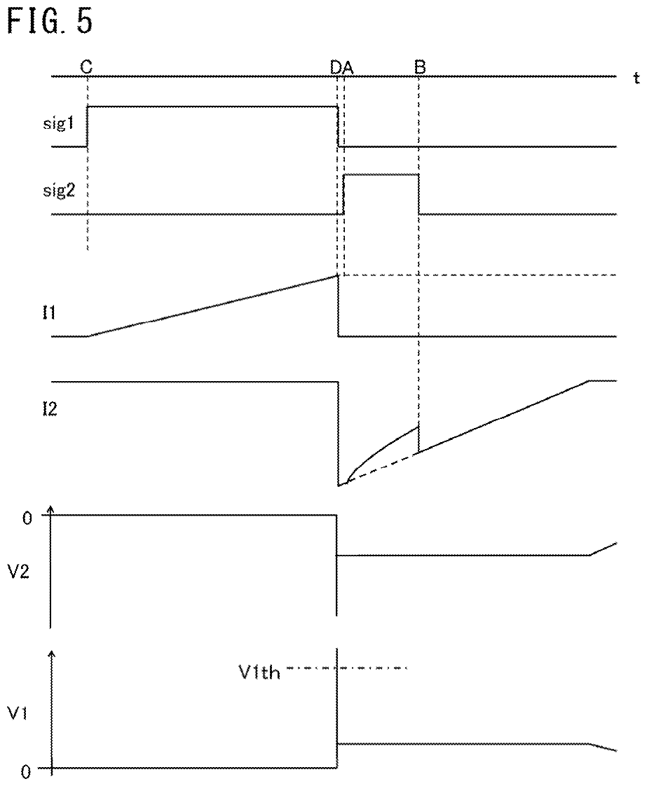

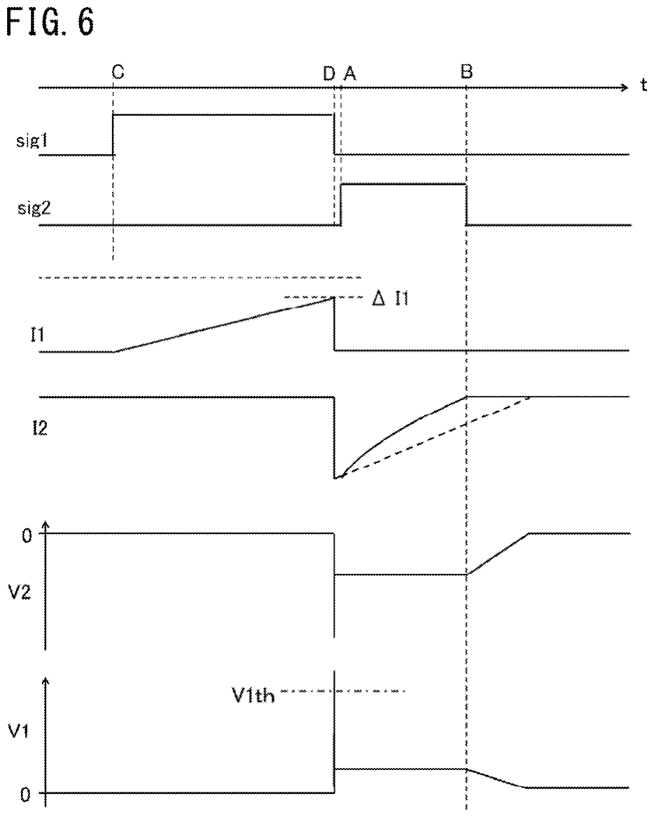

FIG. 5 is a third set of operation waveforms in the ignition apparatus 201; FIG. 6 is a fourth set of operation waveforms in the ignition apparatus 201. Each of FIGS. 5 and 6 represents the operation at a time when because the voltage detected by the plug-consumption detection circuit 60 is high, the consumption of the ignition plug 21 is large and because the plug gap is widened, the ignition energy necessary for the ignitability can further be reduced. In the case where the detected primary voltage V1 exceeds the threshold value V1th, the state in FIG. 5 gradually moves to the state in FIG. 6. When it is determined that the primary voltage V1 detected by the plug-consumption detection circuit 60 exceeds the threshold value V1th and hence the consumption of the ignition plug 21 is large, the period between an ON (at the time point C) and an OFF (at the time point D) of the second switching circuit 31 is gradually shortened to the extent where the dielectric breakdown voltage of the gap between the plug electrodes can be secured. Furthermore, the primary-current cutoff value of the primary coil is suppressed, and immediately after the secondary current occurs, the second switching circuit 31 is turned on (at the time point A). The second switching circuit 31 is turned off (at the time point B) so as to further suppress the ignition energy. The superfluous secondary current I2 that does not contribute to the ignitability is further reduced, so that the consumption of the ignition plug 21 is suppressed from being promoted.

### 2. Embodiment 2

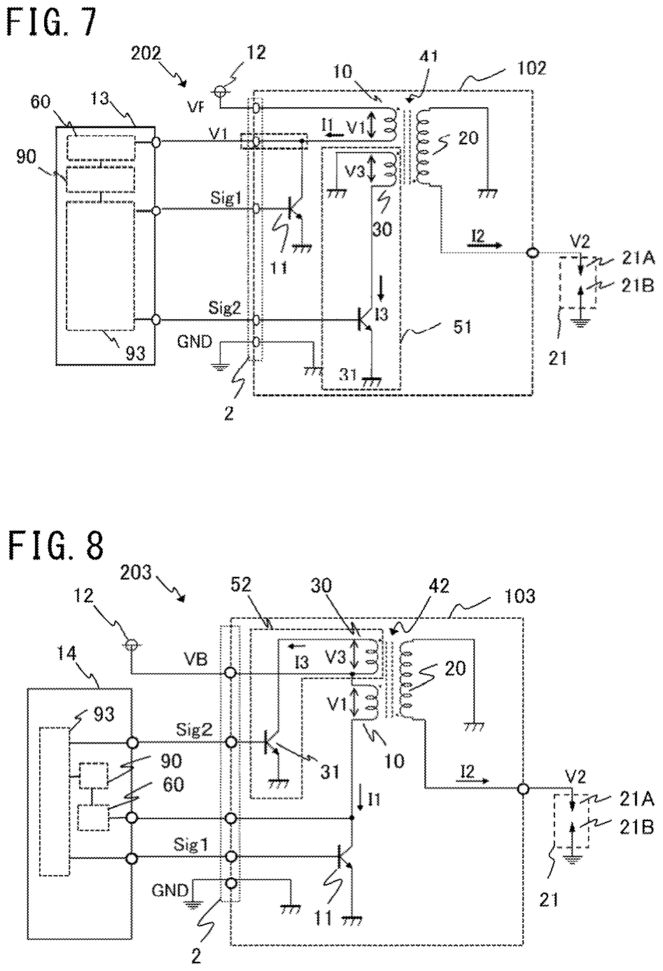

FIG. 7 is a circuit diagram of an ignition apparatus 202 according to Embodiment 2; an ignition coil 41 and an ignition coil apparatus 102 are represented. The configuration in FIG. 7 is different from that of Embodiment 1 represented in FIG. 1 in that the collector of the second switching circuit 31 illustrated as an NPN-type transistor is connected with the high-voltage side of the tertiary coil 30, the emitter thereof is connected with GND, and the low-voltage side of the tertiary coil 30 is connected with GND. That is to say, the tertiary coil 30 and the second switching circuit 31 are connected in series with each other in an electric wire whose both ends are connected with the ground. By way of GND, the both ends of the tertiary coil is connected with (short-circuited) or disconnected from each other by turning on or off the second switching circuit 31.

Embodiment 2 is provided with an energy-changeable circuit 51 having a function the same as that of the energy-changeable circuit according to Embodiment 1. Because energization of a tertiary current I3 makes it possible to reduce the secondary current I2, the secondary current I2 is reduced as is the case with Embodiment 1, so that the effect of suppressing the consumption of the ignition plug 21 can be obtained. The configuration of Embodiment 2 represented in FIG. 7 makes it possible that in comparison with the configuration of Embodiment 1 represented in FIG. 1, the second switching circuit 31 is driven on the GND level. In the circuit in FIG. 1, because the collector and emitter voltages of the second switching circuit 31 are indeterminate with respect to the base thereof, it is required to utilize devices whose withstanding voltages are large; in contrast, in the circuit in FIG. 7, inexpensive devices can be utilized.

In FIG. 7, there has been explained the example in which by way of GND, the both ends of the tertiary coil are connected with (short-circuited) or disconnected from each other; however, also by way of the ignition-coil power source 12, the both ends of the tertiary coil can be connected with (short-circuited) or disconnected from each other. In that case, the configuration is made in such a way that the collector of the second switching circuit 31 illustrated, as an NPN-type transistor, in FIG. 7 is connected with the high-voltage side of the tertiary coil 30, the emitter thereof is connected with the ignition-coil power source 12, and the low-voltage side of the tertiary coil 30 is connected with the ignition-coil power source 12. In addition, the second switching circuit 31 may be changed to a PNP-type transistor.

The plug-consumption detection circuit 60 is connected with a terminal of the primary coil 10 and detects the voltage at the terminal of the primary coil 10 at the first switching circuit 11 side. An input signal for the plug-consumption detection circuit 60 is inputted thereto through an electric wire connected from the connection point between the primary coil 10 and the first switching circuit 11 to the controller 13.

Embodiment 2 is the same as Embodiment 1 in that the plug-consumption detection circuit 60 detects the voltage across a coil magnetically coupled with the secondary coil so as to detect the consumption state of the ignition plug 21; the controller 13 is one and the same.

### 3. Embodiment 3

FIG. 8 is a circuit diagram of an ignition apparatus 203 according to Embodiment 3; an ignition coil 42, an ignition coil apparatus 103, and a controller 14 are represented. In contrast to Embodiment 1 represented in FIG. 1, one end of the primary coil 10 and the other end of the tertiary coil 30 to be utilized in the energy-changeable circuit 52 are connected with one and the same ignition-coil power source 12; the other end of the primary coil 10 is connected with the ground via the first switching circuit 11; one end of the tertiary coil 30 is connected with the ground via the second switching circuit 31. The tertiary coil 30 to be utilized in the energy-changeable circuit 52 is wound in such a way that when energized, there is generated energization magnetic flux whose direction is opposite to that of the energization magnetic flux of the primary coil 10; the collector of the second switching circuit 31 represented as an NPN-type transistor is connected with the low-voltage side of the tertiary coil 30, and the emitter thereof is connected with the ground; energization of the tertiary coil through the DC power source is implemented or cut off by turning on or off the second switching circuit 31.

The first switching circuit 11 is a switching circuit for turning on or off energization from the ignition-coil power source 12 to the primary coil 10. The driving signal Sig1 outputted from the controller 14 is inputted to the first switching circuit 11 and turns on or off the first switching circuit 11.

The second switching circuit 31 is a switching circuit for turning on or off energization from the ignition-coil power source 12 to the tertiary coil 30. The driving signal Sig2 outputted from the controller 14 is inputted to the second switching circuit 31 and turns on or off the second switching circuit 31.

The plug-consumption detection circuit 60 is connected with a terminal of the primary coil 10 and detects the voltage at the terminal of the primary coil 10 at the first switching circuit 11 side. An input signal for the plug-consumption detection circuit 60 is inputted thereto through an electric wire connected from the connection point between the primary coil 10 and the first switching circuit 11 to the controller 14.

### <Main Ignition Control>

After turning on the first switching circuit 11 so as to turning on energization of the primary coil 10, the first switching circuit 11 is turned off so as to turn off the energization of the primary coil 10 and to produce a spark discharge in the ignition plug 21.

### <Control of Energy-Changeable Circuit>

When the tertiary coil 30 is energized during a spark discharge, additional magnetic energy is supplied to the secondary coil 20; thus, the addition of the secondary current I2 that flows in the discharging path makes the absolute value of the secondary current I2 increase. As a result, the spark discharge is strengthened, so that the ignitability of a fuel-air mixture is intensified. On the other hand, due to the strengthening of a spark discharge by the energization of the tertiary coil 30, the secondary current is enlarged and hence the consumption of the ignition plug 21 increases. Accordingly, the tertiary coil 30 is energized only when it is necessary and only during a necessary period.

The controller 14 turns off the first switching circuit 11 and then turns on the second switching circuit 31 after the secondary current has been generated. After the secondary current has been generated, the second switching circuit 31 is turned on, so that energization flux for increasing the secondary current can be generated. Next, in the case where the plug-consumption detection circuit 60 determines that the consumption amount of the ignition plug 21 is large, it can be determined that because the ignitability is raised, it is not required to increase the secondary current. Thus, the duration of a large current is shortened so as to limit the energy required for ignition. The consumption of the ignition plug 21 can be suppressed by shortening the on-period of the Sig2 for controlling the energy-changeable circuit 52 so as to suppress the current flowing in the secondary coil.

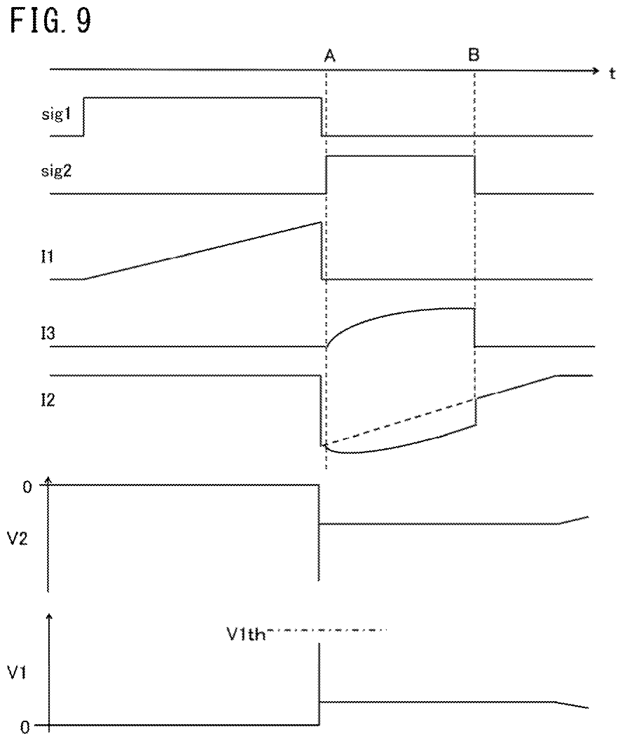

FIG. 9 represents a first set of operation waveforms in the ignition apparatus 203 according to Embodiment 3. FIG. 9 represents the operation at a time when the voltage detected by the plug-consumption detection circuit 60 is low and hence consumption of the ignition plug 21 is small. The primary voltage V1 detected by the plug-consumption detection circuit 60 has not reached the threshold value V1th for determining the consumption amount of the ignition plug 21. The controller 14 turns on the second switching circuit 31 immediately after the secondary current is generated (at a time point A), and then turns off the second switching circuit 31 after an on-period of the second switching circuit 31 elapses (at a time point B). The on-period of the second switching circuit 31 is determined based on the operation state (e.g., the rotation speed, the filling efficiency, or the like) of the internal combustion engine; however, in the case where the consumption of the ignition plug 21 is small and hence continuity of a large secondary current is required, the addition period of the secondary current is set to be long so as to secure the ignitability.

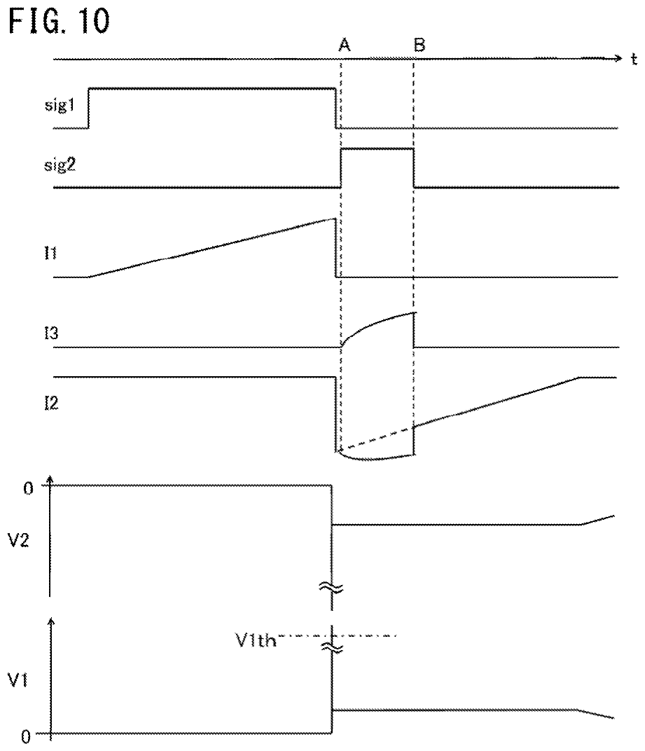

FIG. 10 represents a second set of operation waveforms in the ignition apparatus 203 according to Embodiment 3. FIG. 10 represents the operation at a time when the primary voltage V1 detected by the plug-consumption detection circuit 60 is higher than the threshold value V1th and hence consumption of the ignition plug 21 is large. The controller 14 turns on the second switching circuit 31 immediately after the secondary current is generated (at a time point A), and then turns off the second switching circuit 31 after an on-period of the second switching circuit 31 elapses (at a time point B). Because during the on-period of the second switching circuit 31, the consumption of the ignition plug 21 is large and hence it may be allowed that the ignition energy required for maintaining the ignitability is small, the on-period of the second switching circuit 31 is shortened so as to shorten the increase period of the secondary current. The superfluous secondary current I2 that does not contribute to the ignitability can be reduced, so that the consumption of the ignition plug 21 can be suppressed.

Embodiment 3 is the same as Embodiment 1 in that the plug-consumption detection circuit 60 detects the voltage across a coil magnetically coupled with the secondary coil so as to detect the consumption state of the ignition plug 21.

### 4. Embodiment 4

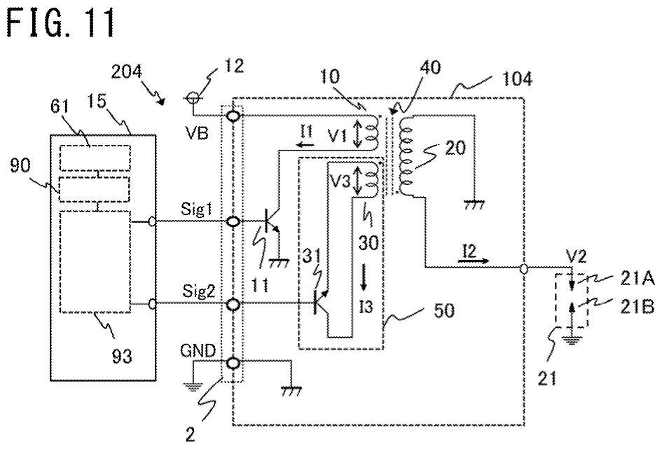

FIG. 11 is a circuit diagram of an ignition apparatus 204 according to Embodiment 4; the ignition coil 40, an ignition coil apparatus 104, and the controller 15 are represented. The configuration in FIG. 11 is different from the configuration of Embodiment 1 represented in FIG. 1 in that a plug-consumption detection circuit 61 has a function of accumulating the number of times of turning on/off of the first switching circuit 11 or the second switching circuit 31, or both of the first switching circuit 11 and the second switching circuit 31. The lifetime ignition count for each replacement of an ignition plug can be obtained by accumulating the number of times of turning on/off. When the accumulated ignition count exceeds a predetermined plug-consumption determination count, it is made possible to determine the consumption of the ignition plug 21.

Here, the on/off count of the first switching circuit 11 signifies the ignition count; however, the on/off count of the second switching circuit 31 signifies the count for which the secondary current has been decreased or increased. Accordingly, by performing subtraction or addition between both of the respective on/off counts or both of the respective weighted on/off counts, it is made possible to more accurately estimate the extent to which the ignition plug has been consumed. For example, the accumulation may be performed in such a way that the number of times of turning on/off the first switching circuit 11 is counted up by 1 for each on/off and the number of times of turning on/off the second switching circuit 31 is counted up by 0.3 for each on/off and that the respective numbers of times of turning on/off are counted up by −0.3 when the secondary current is decreased and by +0.3 when the secondary current is increased.

When due to the lifetime ignition count obtained by the plug-consumption detection circuit 61, the consumption of the ignition plug 21 is large and the ignition energy required for the ignitability becomes small, the ignition apparatus 204 represented in FIG. 11 controls the energy-changeable circuit 50 so as to reduce the superfluous secondary current I2 and to suppress the consumption of the ignition plug 21.

In the present disclosure, by use of at least one of information items on the operation condition of a vehicle, such as the load on the vehicle, the traveling speed, the rotation speed of the engine, the intake air amount, and the fuel supply amount, it is determined whether or not the secondary current I2 can be reduced, so that the energization permission period for the tertiary current is controlled. In addition to that, based on the operation condition of the vehicle, the energization period, the post-energization cutoff period, the on/off repetition period, the energizing timing, and the cutoff timing of the tertiary current are determined. Because based on the operation condition of a vehicle, the energization timing and the cutoff timing of the tertiary current are determined, it is made possible to reduce a superfluous secondary current and suppress the consumption of the ignition plug, while securing the necessary secondary current.

For example, in the case where in a high-speed-rotation and high-load region of an internal combustion engine, a fuel-air mixture is flowing strongly and requires high-voltage ignition energy in a short period, a high-voltage secondary current is supplied in a short period. Because the strong flow makes a discharge ark become long and makes the discharge voltage increase and hence the flammability is raised, the tertiary current should be controlled so that the secondary current is reduced in a short time. In this case, for the high-speed-rotation and high-load operation condition, the tertiary current is increased for a short period and then is decreased. As represented not in FIG. 9 but in FIG. 10, immediately after the first switching circuit 11 is turned off, the second switching circuit 31 is energized for a short period and then is turned off. As a result, because after the second switching circuit 31 is turned off, the secondary current can be decreased, the consumption of the ignition coil can be suppressed.

Moreover, in the case where the consumption of the ignition plug can be estimated based on an accumulated ignition count, a discharge ark becomes long, the discharge voltage increase, and hence the flammability is raised, as is the case with a high-speed-rotation and high-load operation condition; thus, the tertiary current should be controlled so that the secondary current is reduced in a short time. In this case, when the operation condition is detected based on the accumulated ignition count and the consumption of the ignition plug can be estimated, the tertiary current is increased for a short period and then is decreased. As represented not in FIG. 9 but in FIG. 10, immediately after the first switching circuit 11 is turned off, the second switching circuit 31 is energized for a short period and then is turned off. As a result, because after the second switching circuit 31 is turned off, the secondary current can be decreased, the consumption of the ignition coil can be suppressed.

In the case where these control items are applied to any one of Embodiments 1 and 2, the strong flow makes a discharge ark become long and the discharge voltage increase and hence the flammability is raised; therefore, the tertiary current should be made to flow so that the secondary current is reduced in a short time after the ignition has been completed. For a high-speed-rotation and high-load operation condition, after a high-voltage discharge ark has been supplied for a short period, the tertiary current is made to flow so as to continuously decrease the secondary current. After the first switching circuit 11 is turned off and then the ignition is completed, energization of the second switching circuit 31 is started and is continued, so that reduction of the secondary current makes it possible to suppress the consumption of the ignition plug.

Moreover, in the case where these control items are applied to any one of Embodiments 1 and 2 and the consumption of the ignition plug can be estimated based on an accumulated ignition count, a discharge ark becomes long, the discharge voltage increase, and hence the flammability is raised, as is the case with a high-speed-rotation and high-load operation condition; thus, the tertiary current should be controlled so that the secondary current is reduced in a short time. In this case, the operation condition is detected based on the accumulated ignition count; then, the tertiary current is increased for a short period and then is decreased. After a high-voltage discharge ark has been supplied for a short period, the tertiary current is made to flow so as to continuously decrease the secondary current. After the first switching circuit 11 is turned off and then the ignition is completed, energization of the second switching circuit 31 is started and is continued, so that reduction of the secondary current makes it possible to suppress the consumption of the ignition plug.

It may be allowed that the threshold value V1th in the plug-consumption detection circuit 61 is changed based on the operation condition of a vehicle so that while the consumption of the ignition plug 21 is suppressed by optimizing the amount of the secondary current, stable combustion is maintained.

Although the present application is described above in terms of various exemplary embodiments and implementations, it should be understood that the various features, aspects and functions described in one or more of the individual embodiments are not limited in their applicability to the particular embodiment with which they are described, but instead can be applied, alone or in various combinations to one or more of the embodiments. Therefore, an infinite number of unexemplified variant examples are conceivable within the range of the technology disclosed in the present disclosure. For example, there are included the case where at least one constituent element is modified, added, or omitted and the case where at least one constituent element is extracted and then combined with constituent elements of other embodiments.

What is claimed is:

1. An ignition apparatus comprising:
an ignition coil having a primary coil and a secondary coil that is magnetically coupled with the primary coil and supplies a secondary current to an ignition plug;
a first switching circuit that turns on or off energization from a power source to the primary coil;
an energy-changeable circuit that can change magnitude of the secondary current;
a plug-consumption detection circuit that detects that the ignition plug has been consumed; and
a controller that performs on/off-control of the first switching circuit so that the secondary current is generated in the secondary coil by a change in magnetic flux generated in the primary coil and a spark discharge is produced in the ignition plug and that decreases the secondary current by use of the energy-changeable circuit, when determining that the ignition plug has been consumed, based on an output of the plug-consumption detection circuit.

2. The ignition apparatus according to claim 1,
wherein the ignition coil has a tertiary coil that is magnetically coupled with the primary coil and the secondary coil and generates energization flux for decreasing the secondary current,
wherein the energy-changeable circuit has a second switching circuit for turning on or off energization of the tertiary coil, and
wherein when determining that after generation of the secondary current, the ignition plug has been consumed, the controller turns on the second switching circuit so as to decrease the secondary current by a change in magnetic flux in the tertiary coil.

3. The ignition apparatus according to claim 1,
wherein the ignition coil has a tertiary coil that is magnetically coupled with the primary coil and the secondary coil and generates energization flux for increasing the secondary current,
wherein the energy-changeable circuit has a second switching circuit for turning on or off energization of the tertiary coil, and
wherein when determining that after generation of the secondary current, the ignition plug has been consumed, the controller shortens energization duration of the second switching circuit so as to shorten a period in which the secondary current is increased by a change in magnetic flux in the tertiary coil.

4. The ignition apparatus according to claim 1,
wherein the plug-consumption detection circuit detects a voltage across a coil magnetically coupled with the secondary coil, and
wherein in the case where when the spark discharge is generated in the ignition plug, a voltage detected by the plug-consumption detection circuit exceeds a preliminarily set plug-consumption determination voltage, the controller determines that the ignition plug has been consumed.

5. The ignition apparatus according to claim 2,
wherein the plug-consumption detection circuit accumulates at least one of respective on/off counts of the first switching circuit and the second switching circuit, and
wherein when the accumulated value exceeds a predetermined plug-consumption determination count, the controller determines that the ignition plug has been consumed.

6. The ignition apparatus according to claim 1, wherein when determining that the ignition plug has been consumed, the controller shortens an on-time of the first switching circuit.

7. The ignition apparatus according to claim 1, wherein the controller determines an energization timing and a cutoff timing of the energy-changeable circuit, based on an operation condition of a vehicle.
